(19) United States
(12) Patent Application Publication
(10) Pub. No.: US 2002/0026862 A1
(43) Pub. Date: Mar. 7, 2002

(54) METHOD AND APPARATUS FOR CLEAVING A SEMICONDUCTOR WAFER

(76) Inventors: JULIUS R. NAVITSKY, MACUNGIE, PA (US); LAWRENCE EDWIN SMITH, MACUNGIE, PA (US)

Correspondence Address: KEVIN M. MASON, RYAN, MASON & LEWIS, LLP, 1300 POST ROAD, STE. 205, FAIRFIELD, CT, 06430, US

(21) Appl. No.: 09/235,975

(22) Filed: Jan. 22, 1999

(51) Int. Cl. B26F 3/00

(52) U.S. Cl. 83/72; 83/880; 83/454

(57) ABSTRACT

A method and apparatus are disclosed for cleaving a crystalline wafer, such as indium phosphide (InP) or gallium arsenide (GaAs) wafers. A wafer can be scribed with a scribing tool using a straight edge that does not contact the wafer. The wafer is held firmly in place using a vacuum chuck. The wafer can rest in a pocket depressed into the surface of a wafer holder at a depth greater than the wafer thickness. The sliding straight edge can be placed with a perpendicular or parallel orientation to the flat alignment region of the wafer. The straight edge sits on legs that hold the sliding straight edge above the wafer and glide through slots or grooves in the wafer holder. The sliding straight edge can be stopped at the desired alignment point using a scale embedded into the wafer holder. The vacuum holding the wafer in place is under a constant leak by way of a groove from the vacuum chuck to outside air. Thus, the wafer does not stick to the vacuum chuck and can be easily removed without breakage.

### FIELD OF THE INVENTION

The present invention relates to techniques for cleaving a semiconductor wafer, and more particularly, to methods and apparatus for cleaving a semiconductor wafer that allows a wafer to be scribed without damaging the surface of the wafer.

### BACKGROUND OF THE INVENTION

Laser devices are formed from crystalline wafers, such as indium phosphide (InP) or gallium arsenide (GaAs) wafers. FIG. 1 illustrates a conventional wafer 100, which is generally a round, flat surface and often has a flat region 110 along the edge of the wafer for alignment purposes. While most manufacturing on these wafers is done using the full, round wafers, such as those shown in FIG. 1, it is often necessary to break or cleave these wafers into smaller, sometimes accurately dimensioned pieces.

Typically, wafers are cleaved using a hand scribe, such as a diamond-tipped scribe, to place a tick mark on the surface of the wafer. The tick mark becomes the point at which the cleave begins. Once a slight crack is initiated, one edge of the wafer is lifted off the scribing surface, for example, using a tweezer, and the tip of the scribe is used to press on the crack, causing the crack to propagate across the silicon wafer along its natural cleaving planes. Due to the cubic nature of the crystals, the cleavage planes are perpendicular to one another and thus, square or rectangular fragments generally result. One cleavage plane is parallel to the flat alignment region along the edge of the wafer.

The wafers are very fragile and break easily if mishandled. For example, if too much pressure is applied to the top surface of the wafer itself with the hand scribe, the wafer will have a tendency to splinter or shatter in a non-uniform pattern. In addition, it is difficult to cleave the wafers to accurate dimensions without a precise measurement instrument, and a mechanism for holding the wafer in place during the cleaving process. Thus, a straight edge is often placed on the wafer so that an accurate cleave can be achieved. Contacting the surface of the wafer in this manner, however, can result in undesirable scratches and can diminish the useful surface area of the cleaved piece.

As apparent from the above-described deficiencies with conventional techniques for cleaving a crystalline wafer, a need exists for a method and apparatus for cleaving a crystalline wafer that allows the wafer to be scribed using a straight edge that does not come into contact with the wafer.

### SUMMARY OF THE INVENTION

Generally, a method and apparatus are disclosed for cleaving a crystalline wafer. According to one aspect of the invention, the wafer can be scribed with a scribing tool using a straight edge that does not come into contact with the wafer. In one embodiment, the wafer rests in a pocket depressed into the surface of a wafer holder at a depth greater than the wafer thickness.

A sliding straight edge is utilized that can be positioned with a perpendicular or parallel orientation to the flat alignment region along the edge of the wafer. The sliding straight edge is maintained at an offset to the depressed wafer and thereby avoids contact with the wafer. The straight edge glides through slots in the wafer holder and can be stopped at the desired alignment point using a scale embedded into the wafer holder. The slots are positioned to ensure that the straight edge is maintained with either a perpendicular or parallel orientation to the flat alignment region of the wafer.

The wafer is held firmly in place using a vacuum chuck. According to another aspect of the invention, the vacuum holding the wafer in place is under a constant leak by way of a groove from the vacuum chuck to outside air. The wafer will not stick to the chuck and enables easy removal without breakage. Thus, the present invention permits accurate wafer cleaving by solidly and gently holding a wafer with a vacuum chuck and scribing the wafer without laying a straight edge on the wafer surface.

A more complete understanding of the present invention, as well as further features and advantages of the present invention, will be obtained by reference to the following detailed description and drawings.

### BRIEF DESCRIPTION OF THE DRAWINGS

FIG. 1 is a top view of a representative crystalline wafer that can be cleaved using the present invention;

FIG. 2 is a top view of a wafer holder in accordance with the present invention;

FIG. 3 is a cross-sectional side view of the wafer holder of FIG. 2, taken along the line X-X in FIG. 2;

FIG. 4 is a side view of a sliding straight edge in accordance with the present invention; and

FIG. 5 is a bottom view of the sliding straight edge of FIG. 4.

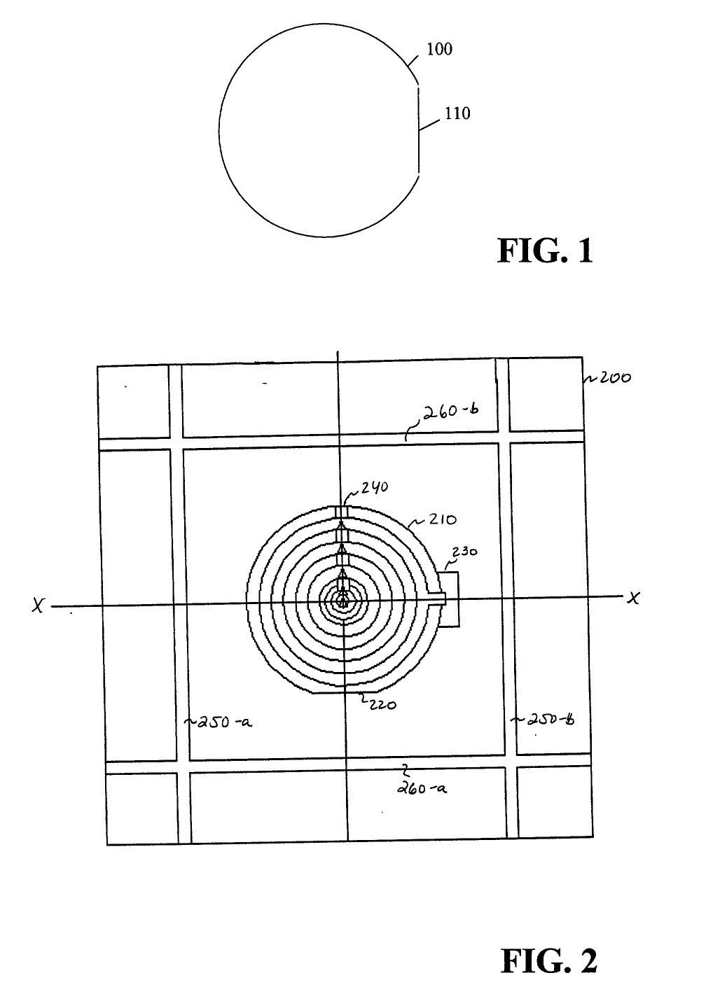

### DETAILED DESCRIPTION

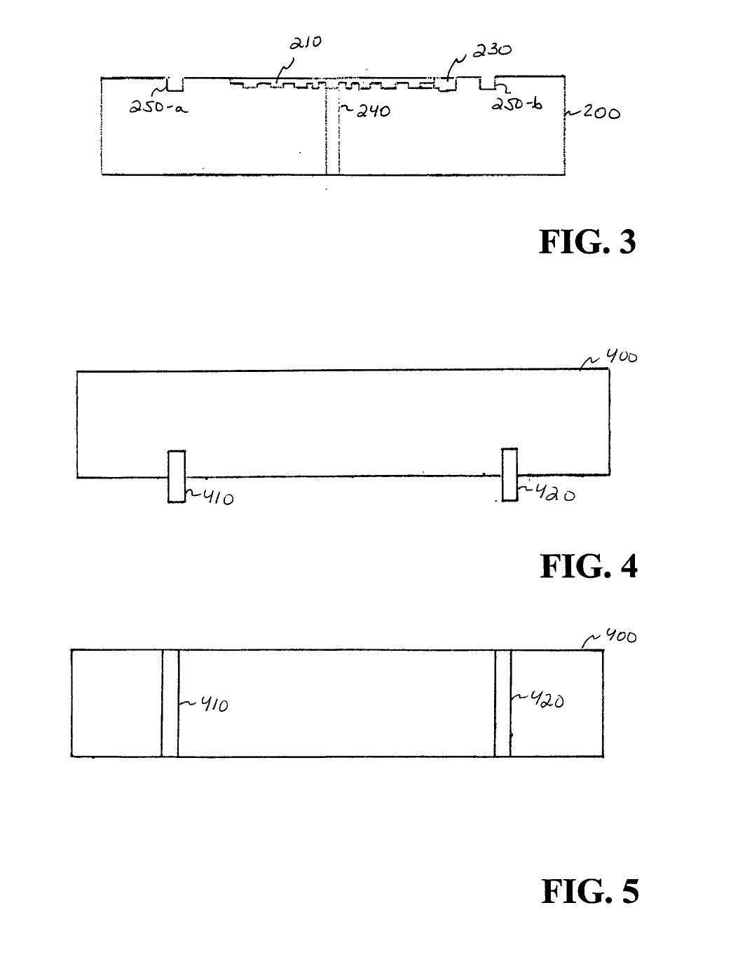

The cleaving device disclosed herein includes a wafer holder 200, shown in FIGS. 2 and 3, for holding a wafer in place during a cleaving process, and a sliding straight edge 400, shown in FIGS. 4 and 5, for scribing a wafer 100 along a desired straight line without laying a straight edge on the wafer surface. As shown in FIG. 2, the wafer holder 200 includes a pocket 210 depressed into the surface of the wafer holder 200 for receiving the wafer 100. In one embodiment, the depth of the pocket 210 is at least as deep as the thickness of the wafer 100. In addition, the pocket 210 optionally includes a flat region 220 along the edge of the pocket 210, that matches the flat alignment region 110, if any, of the wafer 100. In one implementation, the pocket 210 also includes a slot 230 that allows a user to insert and remove the wafer 100 from the pocket 210 using, for example, a finger or a tweezer.

The wafer 100 is held firmly in place using a vacuum chuck 240. According to one feature of the present invention, the vacuum is under a constant leak by way of a groove that extends from the center of the pocket 210 to the outside air at the periphery of the pocket 210, as shown in FIG. 2. Thus, while the vacuum chuck 240 holds the wafer solidly and gently in place, the constant leak ensures that the wafer will not stick to the chuck and enables easy removal without breakage. The base of the groove is connected to a vacuum line. In one illustrative embodiment, the base of the groove is connected to a vacuum line by means of a ⅛-inch air channel.

According to another feature of the present invention, a sliding straight edge 400, shown in FIGS. 4 and 5, is utilized to scribe a wafer 100 along a desired straight line without contacting the wafer surface. The sliding straight edge 400 is maintained with either a perpendicular or parallel orientation to the flat alignment region 110 of the wafer 100 using slots or grooves 250, 260 fabricated in the wafer holder 200.

The sliding straight edge 400 is maintained above the depressed wafer 100, to prevent contact with the wafer 100. The offset may be achieved by (i) ensuring that the depth of the pocket 210 is deeper than the thickness of the wafer 100, as previously indicated, (ii) raising the sliding straight edge 400 on slider legs 410, 420 that travel through the slots 250, 260 and maintain the sliding straight edge 400 at a desired height above the wafer, or (iii) a combination of the foregoing. Thus, the slider legs 410, 420 are positioned on the sliding straight edge 400 to meet the slots or grooves 250, 260 fabricated in the wafer holder 200.

In one illustrative embodiment, the slots or grooves 250, 260 are at least 0.125 inches wide and 0.250 inches deep. In addition, the slider legs are 0.125 inches wide and extend 0.250 inches below the surface of the sliding straight edge 400. In other words, the slots or grooves 250, 260 are milled large enough for the slider legs 410, 420 to glide smoothly. The slider legs 410, 420 may be embodied, for example, as plexiglass inserts that are glued in place.

In one variation, the straight edge 400 glides through the slots 250, 260 in the wafer holder 200 and can be stopped at the desired alignment point using a scale (not shown) embedded into the wafer holder 200.

It is to be understood that the embodiments and variations shown and described herein are merely illustrative of the principles of this invention and that various modifications may be implemented by those skilled in the art without departing from the scope and spirit of the invention. For example, the wafer chuck diameter can be scaled to fit any diameter wafer and can be used on any wafer material that is cleavable, or any material that needs to be scribed.

We claim:

1. A wafer cleaving device, comprising:
a wafer holder for holding said wafer in place; and
a moveable straight edge positioned on said wafer holder without contacting said wafer.

2. The cleaving device according to claim 1, wherein said straight edge is positioned on legs that maintain said straight edge at a desired height above said wafer.

3. The cleaving device according to claim 2, wherein said legs are moveable in perpendicular directions within slots fabricated in said wafer holder.

4. The cleaving device according to claim 1, wherein said straight edge is positioned with a perpendicular or parallel orientation to a flat alignment region along an edge of said wafer.

5. The cleaving device according to claim 1, wherein said straight edge can be positioned at a desired location using a scale embedded into said wafer holder.

6. The cleaving device according to claim 1, further comprising a vacuum chuck for keeping said wafer in place.

7. The cleaving device according to claim 1, wherein said vacuum chuck is under a constant leak by way of a groove from the vacuum chuck to outside air.

8. A wafer cleaving device, comprising:
a wafer holder for holding said wafer in place, said wafer holder having a pocket with a depth that is at least equal to the thickness of said wafer; and
a straight edge that does not contact said wafer.

9. The cleaving device according to claim 8, wherein said straight edge is positioned on legs that maintain said straight edge at a desired height above said wafer.

10. The cleaving device according to claim 8, wherein said straight edge is positioned with a perpendicular or parallel orientation to a flat alignment region along an edge of said wafer.

11. The cleaving device according to claim 8, wherein said straight edge can be positioned at a desired location using a scale embedded into said wafer holder.

12. The cleaving device according to claim 8, further comprising a vacuum chuck for keeping said wafer in place.

13. The cleaving device according to claim 8, wherein said vacuum chuck is under a constant leak by way of a groove from the vacuum chuck to outside air.

14. A wafer cleaving device, comprising:
a wafer holder for holding said wafer in place; and
a straight edge that does not contact said wafer, said straight edge being positioned on legs that maintain said straight edge at a desired height above said wafer.

15. The cleaving device according to claim 14, wherein said wafer holder has a `pocket with a depth that is at least equal to the thickness of said wafer

16. The cleaving device according to claim 14, wherein said straight edge is positioned on legs that maintain said straight edge at a desired height above said wafer.

17. The cleaving device according to claim 14, wherein said straight edge is positioned with a perpendicular or parallel orientation to a flat alignment region along an edge of said wafer.

18. The cleaving device according to claim 14, wherein said straight edge can be positioned at a desired location using a scale embedded into said wafer holder.

19. The cleaving device according to claim 14, further comprising a vacuum chuck for keeping said wafer in place.

20. The cleaving device according to claim 14, wherein said vacuum chuck is under a constant leak by way of a groove from the vacuum chuck to outside air.

21. A method of cleaving a crystalline wafer, comprising the steps of:
holding said wafer in a pocket having a depth that is at least equal to the thickness of said wafer;
positioning a straight edge in a desired position over said wafer without contacting said wafer; and
scribing said wafer to initiate said cleave.

22. The method according to claim 21, wherein said holding step comprises the step of applying vacuum pressure to said wafer.

23. A method of cleaving a crystalline wafer, comprising the steps of:
holding said wafer in place;
positioning a straight edge in a desired position over said wafer without contacting said wafer, said straight edge being positioned on legs that maintain said straight edge at a desired height above said wafer; and
scribing said wafer to initiate said cleave.

24. The method according to claim 23, wherein said holding step comprises the step of applying vacuum pressure to said wafer.
